(19) United States
(12) Patent Application Publication
(10) Pub. No.: US 2013/0175324 A1
(43) Pub. Date: Jul. 11, 2013

(54) THERMAL COMPRESSION HEAD FOR FLIP CHIP BONDING

(71) Applicants: Hui-Shan Chang, Jhongli City (TW); Chia-Lin Hung, Zhongli City (TW); Chung Chieh Huang, Zhongli City (TW)

(72) Inventors: Hui-Shan Chang, Jhongli City (TW); Chia-Lin Hung, Zhongli City (TW); Chung Chieh Huang, Zhongli City (TW)

(73) Assignee: ADVANCED SEMICONDUCTOR ENGINEERING, INC., Kaohsiung (TW)

(21) Appl. No.: 13/348,503

(22) Filed: Jan. 11, 2012

(51) Int. Cl. B23K 20/02; B23K 37/00

(52) U.S. Cl. 228/101; 228/44.7

(57) ABSTRACT

The present invention provides a method and a thermal compression head for flip chip bonding. The thermal compression head includes a main body and a contact portion. The main body has a main body opening. The contact portion has a contact surface and a plurality of openings. The openings communicate with the main body opening. When the contact surface of the contact portion is used to adsorb a chip, the contact surface of the chip has a plurality of adsorbed zones corresponding to the contact surface openings. After the chip is bonded to a substrate, the protrusions of the adsorbed zones are relatively slight. Therefore, the interconnection between the chip and the substrate is ensured.

### BACKGROUND OF THE INVENTION

1. Field of the Invention

The present invention relates generally to chip bonding, and more particularly, to thermal compression bonding.

2. Description of the Related Art

A thermal compression head is used for carrying a chip to a position above a substrate, and then thermally compressing the chip to bond to the substrate. Conventionally, the thermal compression head has only one vacuum hole. In order to provide sufficient suctioning, the size of the vacuum hole is relatively large, for example, 2.5 mm. However, particularly when the chip is very thin, the thermal compression head will cause a large deformation near where the vacuum hole was positioned, which results in poor interconnections between the chip and the substrate.

### SUMMARY OF THE INVENTION

One aspect of the disclosure relates to a thermal compression head. In one embodiment, the thermal compression head includes a main body; and a contact portion, the contact portion including a contact surface and an interior portion, wherein the contact surface includes a plurality of contact surface openings, the contact surface openings extending to the interior portion. The contact portion is disposed on the main body, the contact surface openings in communication with the vacuum source via the interior portion and the opening in the main body. In this embodiment, the thermal compression head is made of a rigid and thermally conductive material, such as stainless steel. To reduce stress on the chip, the contact surface openings are relatively small, preferably, less than about 0.2 mm and are spaced approximately evenly on the surface of the contact surface. The area taken by the contact surface openings is less than about 10% of the surface area of the contact surface.

In an embodiment, the contact portion further includes a recess portion that prevents excess underfill applied to a substrate during the thermal bonding process to build up on the thermal compression head. The recess portion can have a height equal to or greater than about 1 mm and a width equal to or greater than about 0.5 mm.

Another aspect of the disclosure relates to a method for flip chip bonding using the thermal compression head. The method for flip chip bonding includes adsorbing a first surface of a chip, wherein the first surface of the chip has a plurality of adsorbed zones, and the adsorbed zones are spaced apart from each other; and thermally compressing the chip to a substrate. The adsorption is done by vacuum suction. The area of all the adsorbed zones is less than 10% of that of the first surface of the chip.

### BRIEF DESCRIPTION OF THE DRAWINGS

FIGS. 1 to 5 illustrate a thermal compression head and a process for flip chip bonding using the thermal compression head, according to an embodiment of the present invention; and

FIGS. 6 to 10 illustrate a thermal compression head and a process for flip chip bonding using the thermal compression head, according to another embodiment of the present invention.

Common reference numerals are used throughout the drawings and the detailed description to indicate the same elements. The present invention will be more apparent from the following detailed description taken in conjunction with the accompanying drawings.

### DETAILED DESCRIPTION OF THE INVENTION

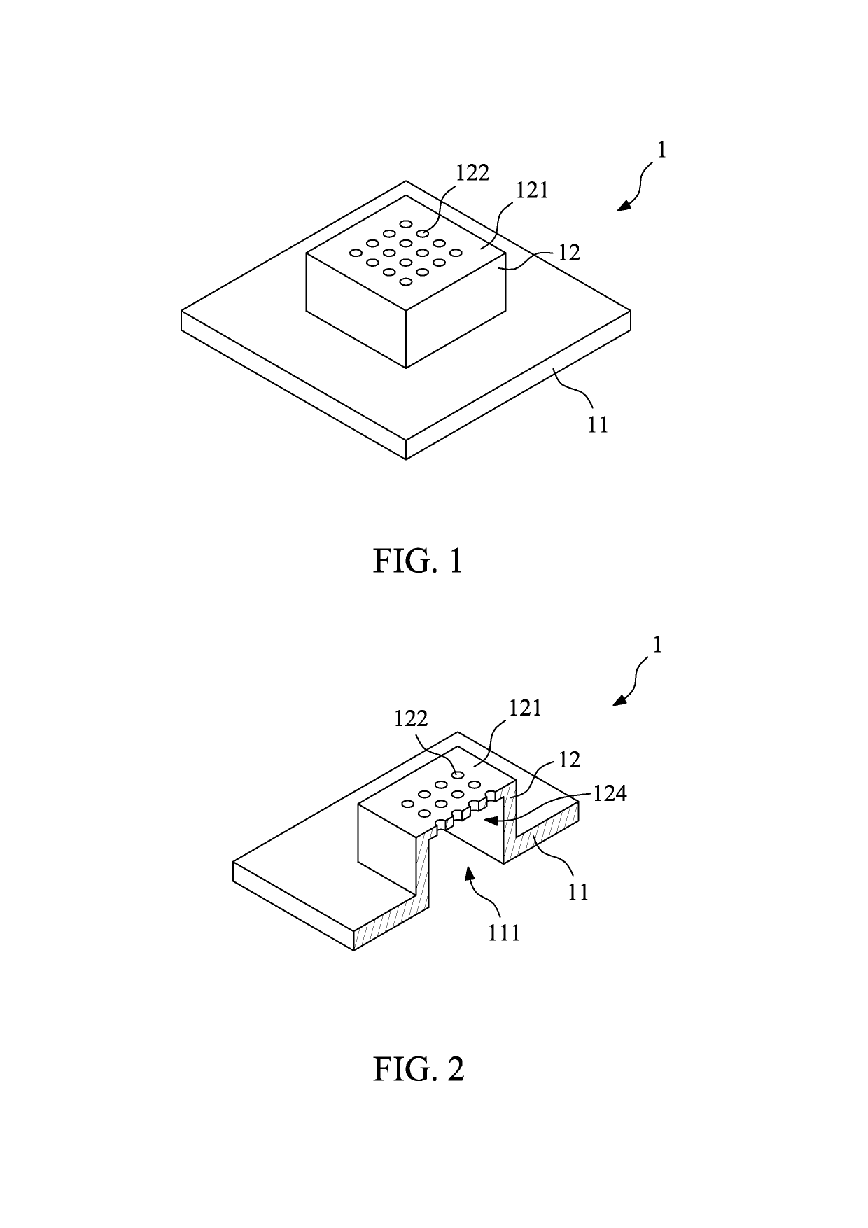

Referring to FIG. 1, a thermal compression head 1 is illustrated.

The thermal compression head 1 comprises a main body 11 and a contact portion 12. In this embodiment, the contact portion 12 is disposed on the main body 11, and the main body 11 and the contact portion 12 are made integrally. In this embodiment, the thermal compression head 1 is made of a rigid and thermally conductive material, such as stainless steel. The contact portion 12 has a contact surface 121 and a plurality of contact surface openings 122 are formed therein. The contact surface 121 of the contact portion 12 is used to contact a chip. The contact surface openings 122 are spaced apart from each other. Preferably, the pitches between the contact surface openings 122 are approximately equal, and the contact surface openings 122 are distributed substantially evenly on the contact surface 121. The widths of the contact surface openings 122 are relatively small. In this embodiment, in order to provide a uniform vacuum suction on the chip and with consideration of mechanical drilling capability, the pitches between the contact surface openings 122 are in a range from about 1 mm to 1.5 mm, and the widths of the contact surface openings 122 are less than about 0.2 mm. In this embodiment, the area of the contact surface 121 taken by the contact surface openings 122 is less than about 10% the surface area of the contact surface 121.

Referring to FIG. 2, a cross-sectional view of FIG. 1 is illustrated. As shown, the main body 11 has a main body opening 111. In this embodiment, the contact portion 12 further has an interior portion 124. The contact surface openings 122 extend to the interior portion 124 and communicate with the main body opening 111. The main body opening 111 communicates with a vacuum source (not shown) so that the thermal compression head 1 can be used to perform a chip suction process through the contact surface openings 122 by vacuum suction.

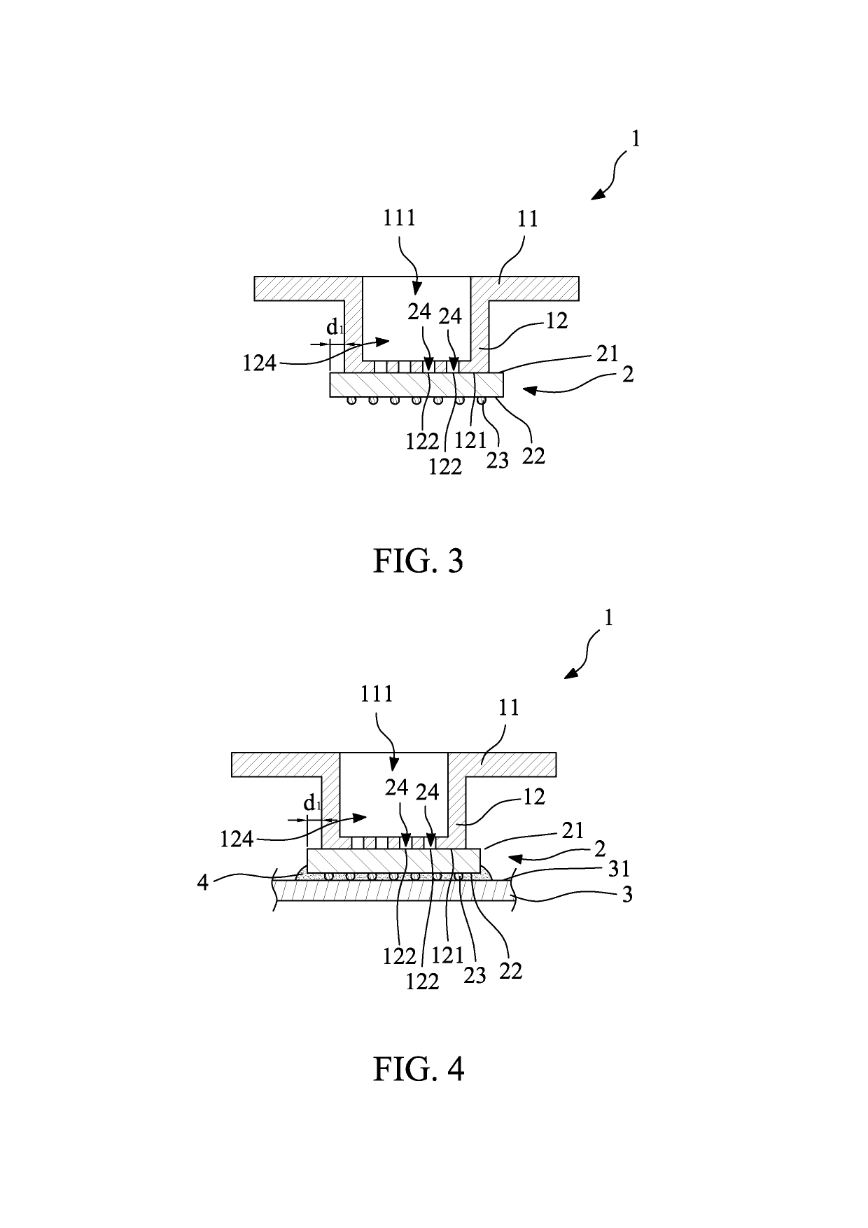

Referring to FIG. 3, a cross-sectional view of a chip suction process is illustrated. As shown, a chip 2 is adsorbed by the thermal compression head 1 when the vacuum source is on. The chip 2 has a first chip surface 21, a second chip surface 22 and a plurality of bumps 23 disposed on the second chip surface 22. The first chip surface 21 is in contact with the contact surface 121 of the thermal compression head 1 and the first chip surface 21 of the chip 2 is adsorbed by the vacuum suction from the contact surface openings 122. Thus, the first chip surface 21 of the chip 2 has a plurality of adsorbed zones 24 corresponding to the contact surface openings 122, and the adsorbed zones 24 are spaced apart from each other. In this embodiment, the area of the contact surface 121 of the thermal compression head 1 is less than that of the first chip surface 21 and a distance d₁ is formed between each edge of the contact portion 12 and an adjacent edge of the chip 2. Preferably, the area of all the adsorbed zones 24 is less than about 10% of that of the first chip surface 21 of the chip 2, and the pitches between the adsorbed zones 24 are approximately equal.

Referring to FIG. 4, a substrate 3 is provided. The substrate 3 has a substrate surface 31. Preferably, a pre-applied underfill 4 is applied to the substrate surface 31 of the substrate 3. The pre-applied underfill 4 is a non-conductive paste (NCP) or a non-conductive film (NCF). Then, the chip 2 is placed on the substrate surface 31 and thermally compressed to the substrate 3 by the thermal compression head 1, so the bumps 23 are electronically connected to pads (not shown) of the substrate 3 and disposed in the pre-applied underfill 4. Thus, the chip 2 is bonded to the substrate 3, and electrically connected to the substrate 3 through the bumps 23. Preferably, in order to prevent excess adhesive 4 from contacting and polluting the thermal compression head 1, the distance d₁ should be larger than or equal to about 0.5 mm and a non-stick coating, such as Teflon, coated on the surfaces of the thermal compression head 1.

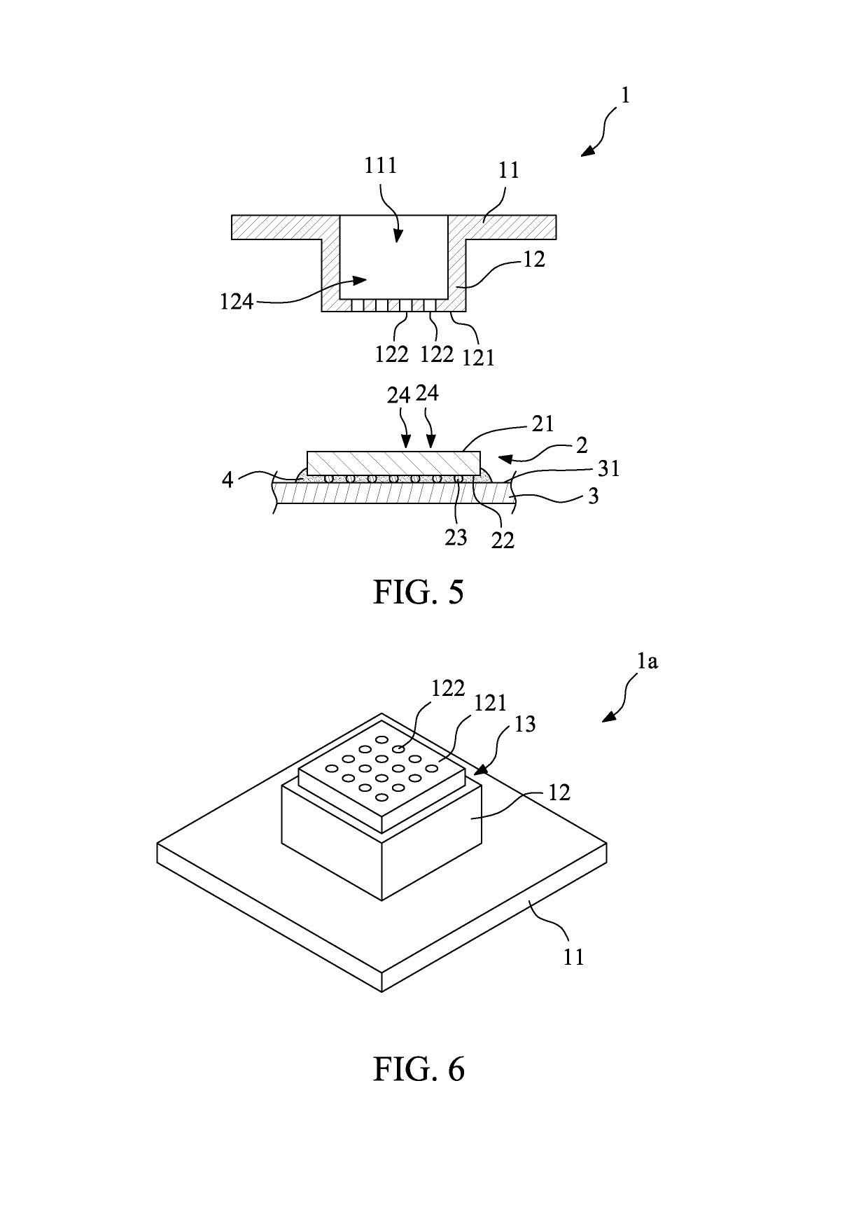

Referring to FIG. 5, when the vacuum source is off, the vacuum suction is released. Then, the thermal compression head 1 leaves the chip 2, and the flip chip bonding process is completed. Because the contact surface openings 122 are relatively small in width, chip deformation at the adsorbed zones 24 caused by the vacuum suction is relatively slight. Therefore, the contact surface 21 of the chip 2 is flat, and the bumps 23 will not deform or be elongated. Thus, the interconnection between the chip 2 and the substrate 3 is ensured.

Referring to FIGS. 6 to 10, a thermal compression head la and a process for flip chip bonding using the thermal compression head la is illustrated. The thermal compression head and the flip chip bonding process of this embodiment are similar to the process described above, and the same elements are designated with the same reference numerals. The difference between the thermal compression head 1a of this embodiment and the above described thermal compression head 1 is the structure of the thermal compression head la which further comprises a recess portion 13.

Referring to FIG. 6, the thermal compression head la is provided. The recess portion 13 is located on the contact portion 12. Preferably, the main body 11 and the contact portion 12 are made integrally. In this embodiment, the thermal compression head 1a is made by a rigid and thermal conductive material, such as stainless steel. The contact portion 12 has the contact surface 121 and the plurality of contact surface openings 122 are formed therein. The contact surface 121 is used to contact a chip 2. The contact surface openings 122 are spaced apart from each other. Preferably, the pitches between the contact surface openings 122 are approximately equal, and the contact surface openings 122 are distributed substantially evenly on the contact surface 121. In this embodiment, in order to provide a uniform vacuum suction on the chip and with consideration of the mechanical drilling capability, the pitches between the contact surface openings 122 are in a range from about 1 mm to 1.5 mm, and the size of the contact surface openings 122 are less than about 0.2 mm. The area of the contact surface 121 taken by the contact surface openings 122 is less than about 10% the surface area of the contact surface 121.

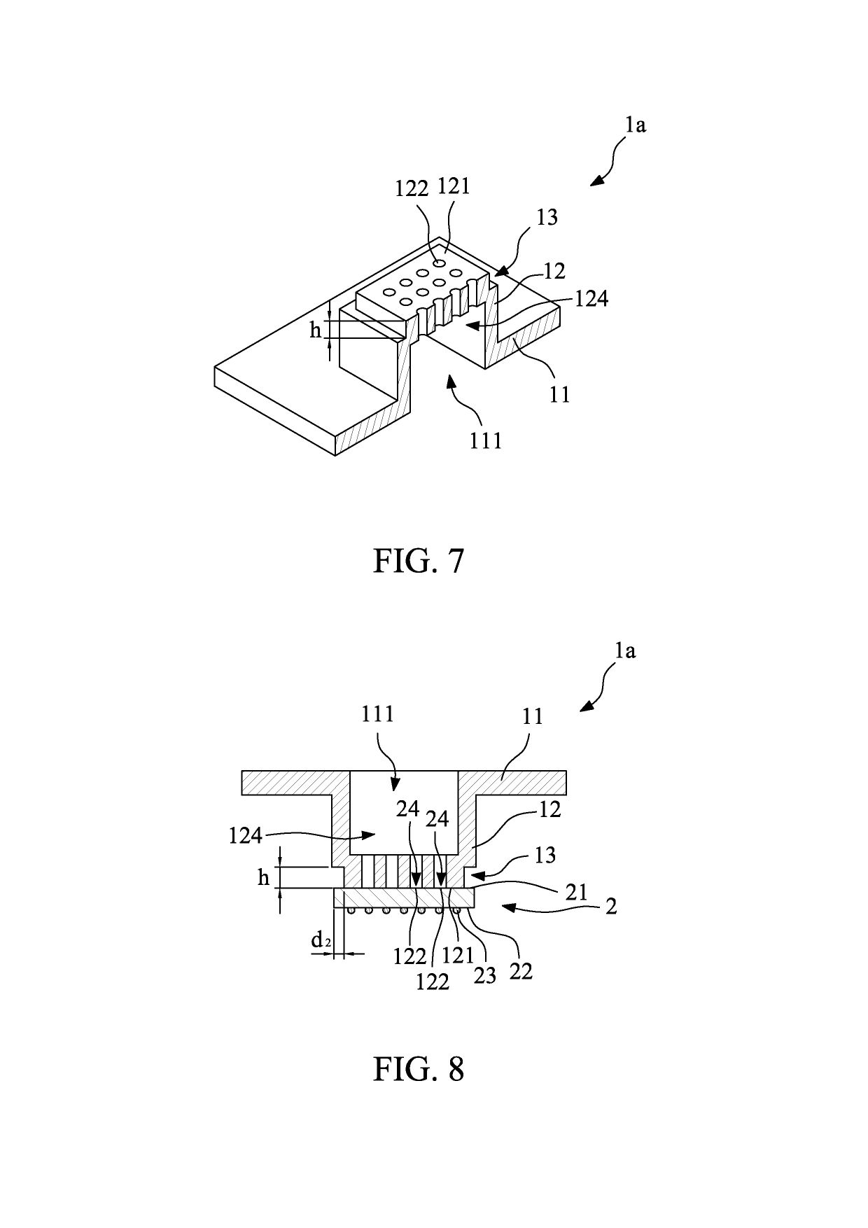

Referring to FIG. 7, a cross-sectional view of FIG. 6 is illustrated. The recess portion 13 has a height h. The contact surface openings 122 extend to the interior portion 124 and communicate with the main body opening 111. The main body opening 111 communicates with a vacuum source (not shown) so that the thermal compression head 1a can be used to perform a chip suction process through the contact surface openings 122 by vacuum suction.

Referring to FIG. 8, a cross-sectional view of a chip suction process is illustrated. As shown, the chip 2 is adsorbed by the thermal compression head la when the vacuum source is on. The first chip surface 21 is contact with the contact surface 121 of the thermal compression head la and the first chip surface 21 of the chip 2 is adsorbed by the vacuum suction from the contact surface openings 122. Thus, the first chip surface 21 of the chip 2 has a plurality of adsorbed zones 24 corresponding to the contact surface openings 122. In this embodiment, the area of the contact surface 121 is smaller than that of the chip 2, thus, there is a distance d₂ formed between the edge of the recess portion 13 and the edge of the chip 2.

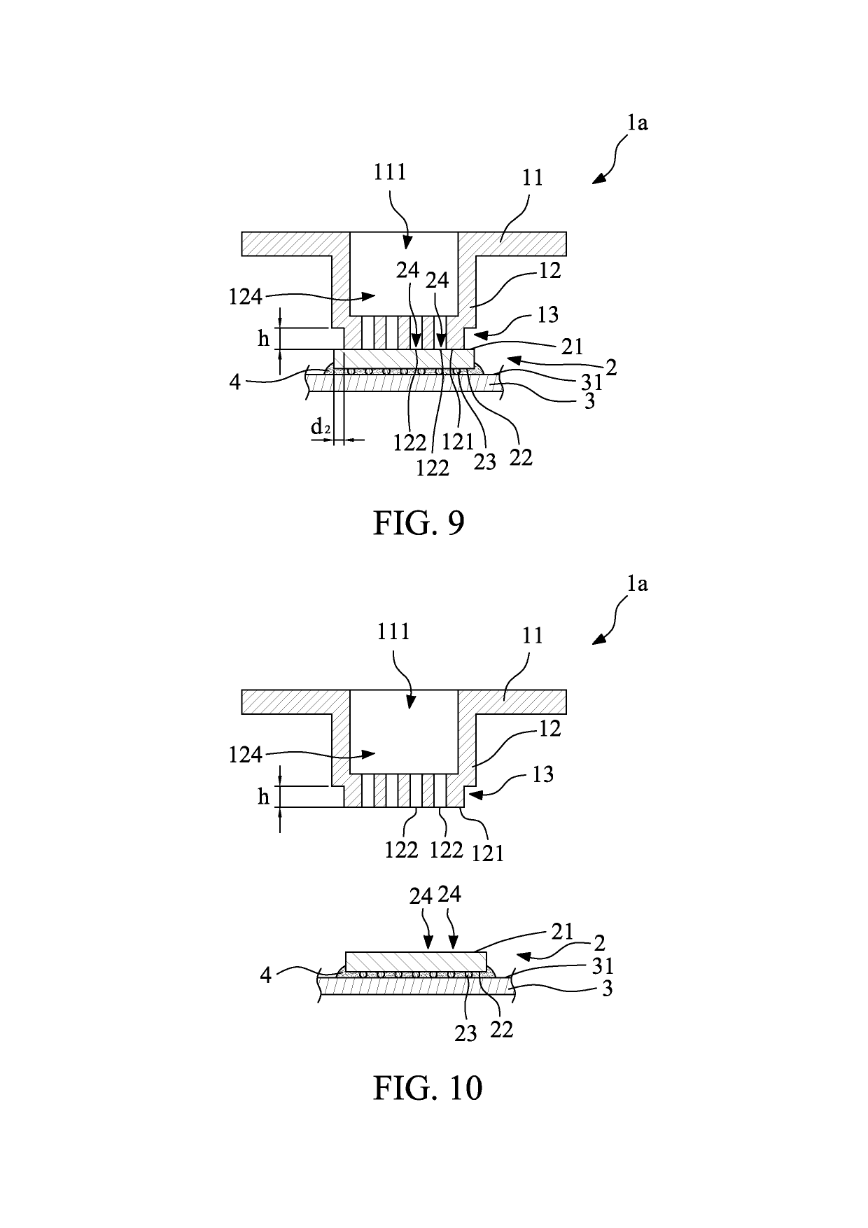

Referring to FIG. 9, the chip 2 is thermally compressed to a substrate 3 by the thermal compression head 1a, so the bumps 23 are disposed in the pre-applied underfill 4. Thus, the chip 2 is bonded to the substrate 3, and electrically connected to the substrate 3 through the bumps 23. During the compression process, if the amount of the pre-applied underfill 4 is not controlled perfectly, excess of the pre-applied underfill 4 will reach the contact surface 21 of the chip 2. However, in this embodiment, a space of height h can accommodate the excess underfill 4 so as to prevent the excess underfill 4 from contacting and polluting the thermal compression head la. Preferably, the distance d₂ formed between the edge of the contact portion 12 and that of the chip 2 should be larger than or equal to about 0.5 mm, the height h of the recess portion 13 should be larger than or equal to about 1 mm and a non-stick coating, such as Teflon, coated on the surfaces of the thermal compression head 1a.

Referring to FIG. 10, when the vacuum source is off, the vacuum suction is released. Then, the thermal compression head 1a leaves the chip 2, and the flip chip bonding process is completed.

While the invention has been described and illustrated with reference to specific embodiments thereof, these descriptions and illustrations do not limit the invention. It should be understood by those skilled in the art that various changes may be made and equivalents may be substituted without departing from the true spirit and scope of the invention as defined by the appended claims. The illustrations may not be necessarily drawn to scale. There may be distinctions between the artistic renditions in the present disclosure and the actual apparatus due to manufacturing processes and tolerances. There may be other embodiments of the present invention which are not specifically illustrated. The specification and the drawings are to be regarded as illustrative rather than restrictive. Modifications may be made to adapt a particular situation, material, composition of matter, method, or process to the objective, spirit and scope of the invention. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations are not limitations of the invention.

1. A thermal compression head, comprising:
a main body; and
a contact portion, the contact portion including a contact surface and an interior portion, wherein the contact surface includes a plurality of contact surface openings, the contact surface openings extending to the interior portion and in communication with a vacuum source via the interior portion and an opening in the main body.

2. (canceled)

3. (canceled)

4. The thermal compression head of claim 1, wherein the contact portion is disposed on the main body.

5. The thermal compression head of claim 1, wherein the main body and the contact portion are made integrally.

6. The thermal compression head of claim 1, wherein the contact surface of the contact portion is useable for carrying a chip.

7. The thermal compression head of claim 1, wherein the thermal compression head is useable for chip bonding.

8. The thermal compression head of claim 1, wherein an area taken by the contact surface openings is less than about 10% of the surface area of the contact surface.

9. The thermal compression head of claim 1, wherein the contact surface openings are spaced apart from each other.

10. The thermal compression head of claim 1, wherein widths of the contact surface openings are less than about 0.2 mm.

11. The thermal compression head of claim 1, wherein pitches between the contact surface openings are in a range of about 1 mm to 1.5 mm.

12. The thermal compression head of claim 11, wherein pitches between the openings are approximately equal.

13. The thermal compression head of claim 1, wherein the contact portion includes a recess portion.

14. The thermal compression head of claim 13, wherein the recess portion has a height equal to or greater than about 1 mm and a width equal to or greater than about 0.5 mm.

15. The thermal compression head of claim 1, wherein at least one surface of the thermal compression head is coated with a non-stick coating.

16. A thermal compression head, comprising:
a main body having an opening capable of connection to a vacuum source; and
a contact portion disposed on the main body, the contact portion including a contact surface and an interior portion, wherein the contact surface includes a plurality of contact surface openings extending to the interior portion, the contact surface openings in communication with the vacuum source via the interior portion and the opening in the main body.

17. The thermal compression head of claim 16, wherein widths of the contact surface openings are less than about 0.2 mm.

18-20. (canceled)

21. A thermal compression head, comprising:
a main body having an opening capable of connection to a vacuum source; and
a contact portion disposed on the main body, the contact portion including a contact surface and a recess portion, the contact surface including a plurality of contact surface openings; and
an interior portion, wherein the contact surface openings extend to the interior portion and are in communication with the vacuum source via the opening in the main body.

22. The thermal compression head of claim 21, wherein the recess portion defines a stepped edge.

23. The thermal compression head of claim 21, wherein the recess portion borders lateral sides of the contact surface.

24. The thermal compression head of claim 1, wherein when the vacuum source is on, the thermal compression head is capable of adsorbing a surface of a chip by vacuum suction from the contact surface openings.

25. The thermal compression head of claim 21, wherein the recess portion defines a stepped edge around an outer periphery of the contact surface.
